(19) United States
(12) Patent Application Publication
(10) Pub. No.: US 2026/0298282 A1
(43) Pub. Date: Oct. 1, 2026

(54) DIRECTIONALLY PEELABLE SUCTION SEALING APPARATUS

(71) Applicant: Israel Harry Zimmerman, Los Angeles, CA (US)

(72) Inventor: Israel Harry Zimmerman, Los Angeles, CA (US)

(21) Appl. No.: 19/091,625

(22) Filed: Mar. 26, 2025

(51) Int. Cl. F16B 47/00

(52) U.S. Cl. CPC F16B 47/00

(57) ABSTRACT

A suction sealing apparatus includes a seal member and a cover member, with the seal member featuring a first side for suction sealing to a reference surface and a second side. The seal member includes a suction release feature near its peripheral edge. The cover member overlies the seal member second side and operably engages the suction release feature. The cover member is manipulatable in a predetermined manipulation direction to activate the suction release feature in order to disengage the seal member from the reference surface, while allowing manipulation in other directions without releasing the seal.

### BACKGROUND

### Field

The present disclosure is directed to suction sealing apparatus that can be releasably suctioned onto a surface.

### Description of the Prior Art

By way of background, suction sealing devices are known in the art and typically employ a seal member to create a vacuum seal with a reference surface. Traditional devices often face limitations when it comes to disengagement from the reference surface, as they lack a structured mechanism for easily releasing the seal. Such devices often require significant effort or the use of tools to break the seal, which can lead to inconvenience and possible damage to the sealing device and/or the reference surface. Furthermore, devices that incorporate features to facilitate seal release do not typically allow for selective directional manipulation, which may result in inefficient disengagement following use. Current solutions do not adequately address these challenges, presenting opportunities for improvements in suction sealing apparatus functionality and usability.

### SUMMARY

A suction sealing apparatus includes a seal member and a cover member. The seal member has a first side, a second side, and a peripheral edge. A suction release feature is formed on the seal member proximate to the seal member peripheral edge. The seal member first side is configured for suction sealing engagement of the seal member to a reference surface. The cover member overlies the seal member second side and operably engages the suction release feature. The cover member is manipulatable in a predetermined manipulation direction to activate the seal member suction release feature in order to release the suction sealing engagement of the seal member. The cover member is manipulatable in other directions without activating the seal suction release feature and without releasing the suction sealing engagement of the seal member.

In another aspect, a method for using the suction sealing apparatus includes adhering the suction sealing apparatus to a reference surface by placing the seal member first side on the reference surface to effect the suction sealing engagement between the seal member and the reference surface. The method further includes detaching the suction sealing apparatus from the reference surface by manipulating the cover member in the predetermined manipulation direction to activate the suction release feature and thereby release the suction sealing engagement of the seal member.

### BRIEF DESCRIPTION OF THE DRAWINGS

FIG. 1 is a front perspective view showing a suction sealing apparatus according to an example embodiment.

FIG. 2 is a top plan view of the suction sealing apparatus of FIG. 1.

FIG. 3 is a front elevation view of the sealing apparatus of FIG. 1.

FIG. 4 is a rear perspective view of the suction sealing apparatus of FIG. 1.

FIG. 5 is an enlarged perspective view showing detail “O” of FIG. 4.

FIG. 6 is an exploded perspective view of the suction sealing apparatus of FIG. 1, showing an example seal member and an example cover member that may be used therein.

FIG. 7 is a cross-sectional centerline view taken along line 7-7 in FIG. 2, showing the suction sealing apparatus of FIG. 1 with its seal member in sealing engagement with a reference surface.

FIG. 8 is a cross-sectional centerline view showing the suction sealing apparatus of FIG. 1, with its seal member being directionally peeled away from a reference surface.

FIG. 9 is a rear perspective view of a suction sealing apparatus according to another example embodiment.

FIG. 10 is an enlarged perspective view showing detail “Y” of FIG. 9.

FIG. 11 is front elevation view of the suction sealing apparatus of FIG. 9.

FIG. 12 is an upper perspective view showing an example seal member that may be used in the suction sealing apparatus of FIG. 9.

FIG. 13 is a top plan view of the example seal member of FIG. 12.

FIG. 14 is a side view of the example seal member of FIG. 12.

FIG. 15 is a rear elevation view of the example seal member of FIG. 12.

FIG. 16 is a cross-sectional centerline view of the example seal member of FIG. 12, taken along line 16-16 in FIG. 13.

FIG. 17 is a cross-sectional centerline view taken along line 17-17 in FIG. 9, showing the suction sealing apparatus of FIG. 9 with its seal member in sealing engagement with a reference surface.

FIG. 18 is a cross-sectional centerline view showing the suction sealing apparatus of FIG. 9 with its seal member pressed against a reference surface.

FIG. 19 is a cross-sectional centerline view showing the suction sealing apparatus of FIG. 9 with its seal member being directionally peeled away from a reference surface.

FIG. 20 is a cross-sectional centerline view showing a suction sealing apparatus according to another example embodiment, with its seal member in sealing engagement with a reference surface.

FIG. 21 is a cross-sectional centerline view showing the suction sealing apparatus of FIG. 20, with its seal member being directionally peeled away from a reference surface.

FIG. 22 is a cross-sectional perspective view showing a suction sealing apparatus according to another example embodiment, with its seal member in sealing engagement with a reference surface.

FIG. 23 is a partial cross-sectional perspective view showing a suction sealing apparatus according to another example embodiment, with its seal member in sealing engagement with a reference surface.

### DETAILED DESCRIPTION

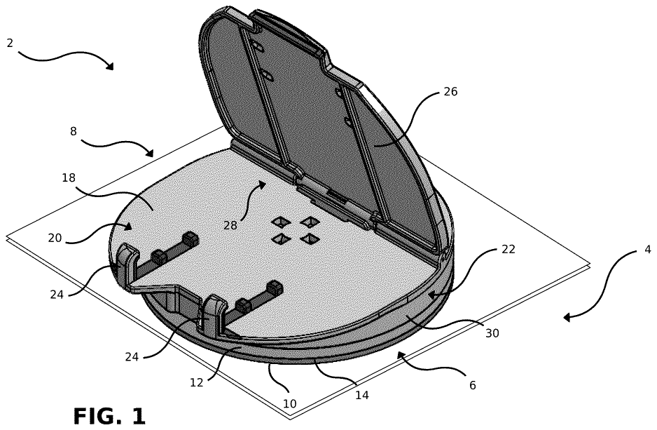

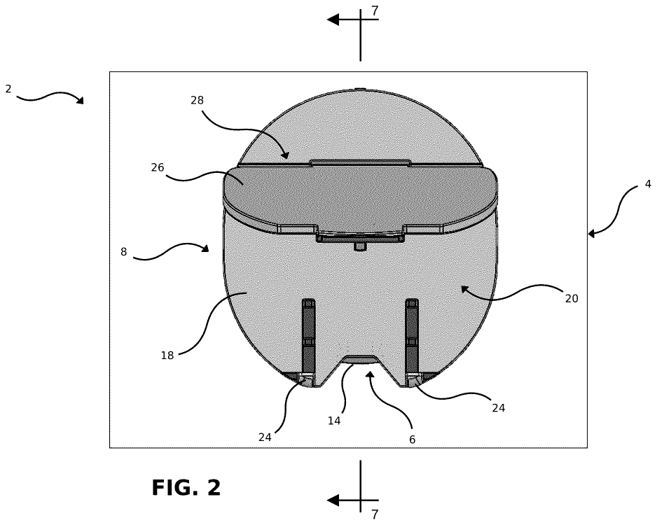

Turning now to the drawings, in which like reference numbers illustrate like structure in all the several views, FIGS. 1-3 illustrate one possible embodiment a suction sealing apparatus 2 that may be constructed in accordance with the present disclosure. The suction sealing apparatus 2 may be used for various applications, including to hold, carry or restrain one or more items or materials, such as on a horizontal or near horizontal surface, or even on a vertical or near-vertical surface. In the disclosed embodiment, the suction sealing apparatus 2 is designed according to a non-limiting example as a holder for an electronic device having a display, such as a smartphone or a tablet computer.

Advantageously, the suction sealing apparatus 2 provides quick-release and attachment capability that allows the apparatus to be secured to a reference surface 4 and quickly released therefrom, but only when manipulated in a specific manipulation direction. The suction sealing apparatus 2 will resist detachment from the reference surface 4 when manipulated in other directions, which is beneficial for many applications. Although the reference surface 4 is shown as being substantially horizontal (such as a tabletop or countertop, it could also be used on a substantially vertical surface (such as a wall, door, window, etc.), as previously noted. The reference surface 4 could also have an orientation lying somewhere between vertical and horizontal.

In the illustrated embodiment, the suction sealing apparatus 2 includes a seal member 6 and a cover member 8 that overlies the seal member and substantially covers it. The cover member 8 is attached or otherwise engaged with the seal member 6 to form an integrated assembly.

The seal member 6 may be formed of a non-porous resilient material, such as injection-moldable rubber having a hardness and density suitable to enable the seal member to deform and seal against the reference surface 4. For example, silicone rubber with a shore hardness of between Shore A 20 to Shore A 60 may be used, with Shore A 40 rubber having been found to produce very satisfactory results. Other hardness values may also be suitable depending on the application for which the suction sealing apparatus 2 is used.

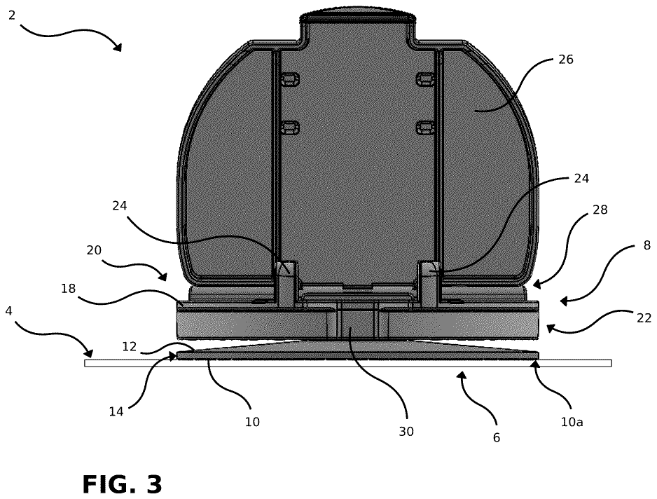

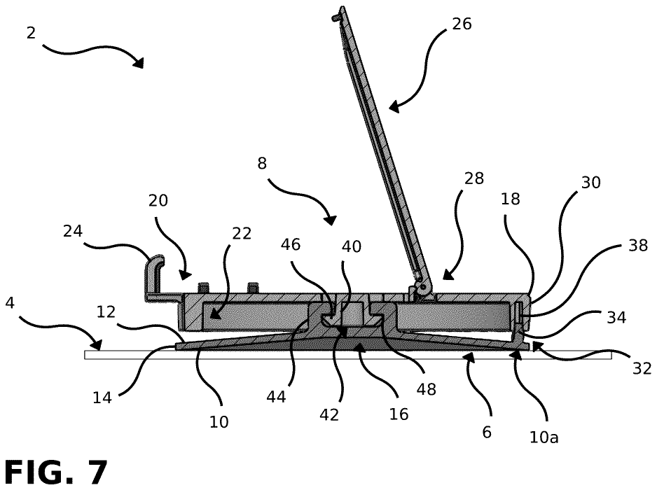

The seal member 6 may be formed as a suction cup having first and second sides, namely a seal member lower side 10 and a seal member upper side 12. The seal member lower side 10 and the seal member upper side 12 are surrounded by a peripheral edge 14 that may be circular in shape (or of other suitable geometry). The seal member lower side 10 may be configured as a smooth uninterrupted surface suitable for suction sealing engagement of the seal member 6 to the reference surface 4. If desired, the seal member 6 may have a cambered suction cup configuration (see FIG. 3) that defines a central concavity 16 on the seal member lower side 10 (see FIG. 7). The concavity 16 ensures that a peripheral region 10a (see FIG. 3) of the seal member lower side 10, which borders the seal member peripheral edge 14, will firmly contact the reference surface 4. The peripheral region 10a engages the reference surface 4 to form a robust continuous ring seal when the suction sealing apparatus 2 is brought into suction engagement therewith. The remainder of the seal member lower side 10 may also seal against the reference surface 4. However, a central region of the seal member lower side 10 may not seal, and may instead remain spaced above the reference surface 4 as a residual concavity.

The cover member 8 overlies and substantially covers the seal member upper side 12. It may be formed of a rigid or semi-rigid material such as an injection-moldable thermoplastic or thermoset plastic. A lightweight metal or composite material could also be used. The cover member 8 may be formed to define a main base structure 18 having an upper base portion 20 and a lower base portion 22. The lower base portion 22 is situated in proximally to the seal member 6, in facing relationship with the seal member upper side 12.

The upper base portion 20 may be configured in a variety of ways according to the application for which the suction sealing apparatus 2 is designed. In the illustrated embodiment wherein the suction sealing apparatus 2 serves as a smartphone or tablet holder, the upper base portion 20 has a flat platform shape for supporting the device to be held. In this embodiment, the cover member includes additional secondary device holding structures, namely, a pair of fingers 24 to engage a lower edge of the device and a foldable lid 26 to engage a back side of the device. The lid 26 is pivotally mounted to the upper base portion 20 by way of a hinge 28 so that it can be pivoted between a folded stowage position and an open operational position.

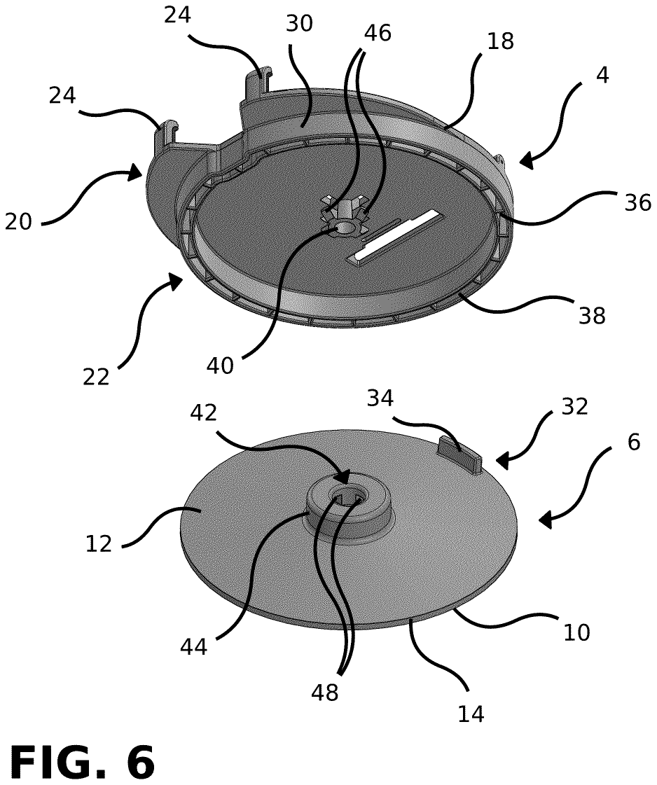

The lower base portion 20 includes a seal member pressing structure 30 that is sized and configured for pressing engagement onto the seal member upper side 12, in close proximity to the seal member peripheral edge 14. In the illustrated embodiment, the seal member pressing structure 30 is formed as a continuous ring flange that follows the shape of the seal member peripheral edge 14. This ring flange configuration can be seen in FIG. 6. In other embodiments, the seal member pressing structure 30 could have other shapes. It could also be segmented or otherwise non-continuous rather than continuous.

As shown in FIG. 3, the seal member 6 and the cover member 8 may be configured and arranged so that the seal member pressing structure 30 does not initially contact the seal member upper side 12, and will only press onto the seal member 6 when the cover member 8 is tilted or pushed or weighted downwardly. When such contact occurs, the downward pressure exerted by the seal member pressing structure 30 will enhance the sealing engagement of the seal member 6 against the reference surface 4. This is due to the seal member pressing structure 30 being in proximity to the seal member peripheral edge 14. In other embodiments, the seal member 6 and the cover member 8 may be configured and arranged so that the seal member pressing structure 30 always rests on the seal member upper side 12, or alternatively, so that it never contacts the seal member 6.

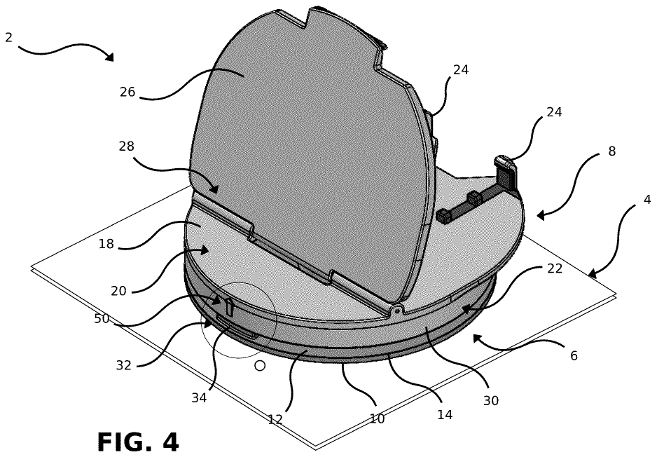

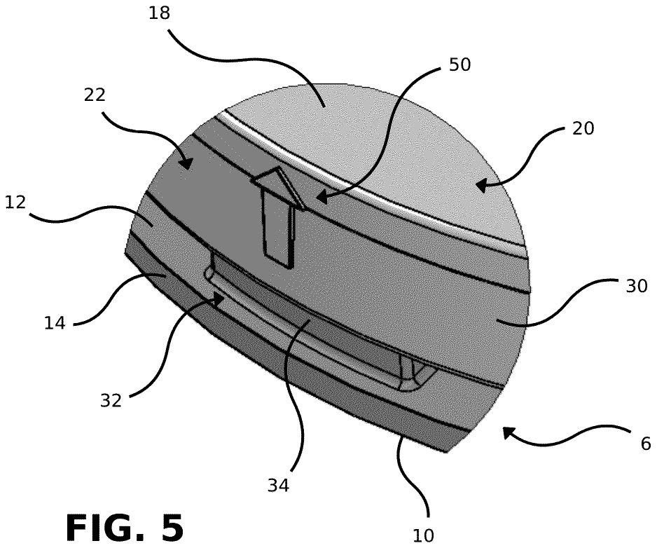

Turning now to FIGS. 4-5, the seal member 6 includes a suction release feature 32 located proximate to the seal member peripheral edge 14 The suction release feature 32 is situated for operable engagement with the cover member 8. When activated by the cover member 8, the suction release feature 32 enables rapid release of the suction sealing apparatus 2 by facilitating directional peeling of the seal member 6 away from the reference surface 4. The directional peeling commences at a peel initiation region location on the peripheral edge 14, where the suction release feature 32 is situated, and then propagates away therefrom across the seal member lower side 10 until the seal member 6 is released. As will be seen, the suction release feature 32 may take various forms. In the illustrated embodiment shown in FIGS. 4-5, the suction release feature 32 is implemented as a pull member 34. The pull member 34 may be integrally formed as part of the seal member 6 and arranged to extend upwardly from the seal member upper side 12, where it attaches to the lower base portion 22 of the cover member 8.

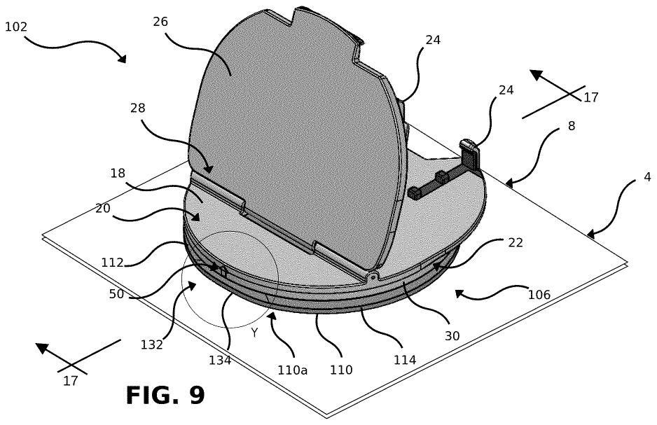

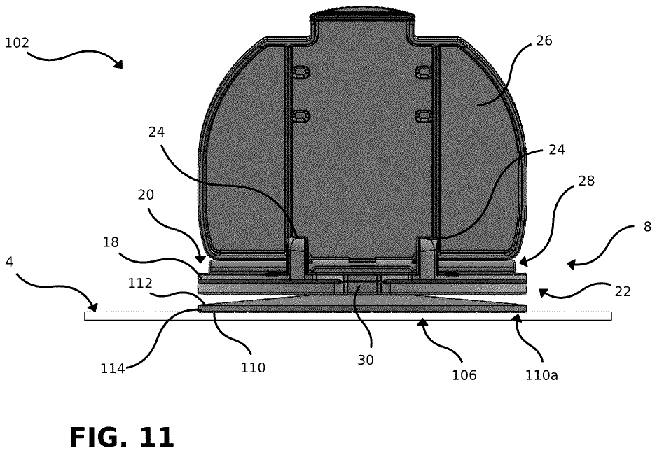

Further suction release feature embodiments are respectively depicted in FIGS. 9-19 and 20-21, 22 and 23, and are discussed in more detail below. Each of these embodiments utilizes an alternative suction release feature design. Although not shown, further embodiments could be implemented wherein there is more than one instance of a suction release feature in a single suction sealing apparatus. By way of example, such embodiments could have two suction release features situated 180 degrees apart, three suction release features situated 120 degrees apart, four suction release features located 90 degrees apart, and so on. Several suction release features could also be grouped together to broaden (e.g., widen) the peel initiation region at the seal member's peripheral edge 14.

An example form of attachment between the pull member 34 and the cover member 8 is shown in FIG. 6. As can be seen in this figure, the seal member pressing structure 30 on the lower base portion 22 of the cover member 8 may be formed as a dual wall structure with intermittent structural reinforcement ribs 36. Two of these ribs are spaced to form a receptacle 38 that receives the pull member 34 and engages it with a slight interference fit. This attachment results in the cover member 8 being operable to pull upwardly on the pull member 34 when the cover member is lifted and/or tilted.

With continuing reference to FIG. 6, a central portion of the seal member upper side 12 is configured for operable engagement of the seal member 6 with a central portion of cover member 8. Such operable engagement may be provided by any centrally located structural arrangement that allows the cover member 8 to tilt or pivot while maintaining the cover member in a stable lateral position relative to seal member 6. This may include any suitable formation (or set of formations) on the seal member upper side 12 that can serve as a fulcrum point (or set of fulcrum points) for the cover member 8.

In the illustrated embodiment, the central operable engagement between the cover member 8 and the seal member upper side 12 results from the cover member being attached to the seal member upper side using a locking attachment arrangement at a single central location. Although not shown, the cover member 8 could also be attached to the seal member upper side 12 at more than one central location, such as by providing a group of several centralized points of attachment. In FIG. 6, the locking attachment arrangement is provided by a downwardly-extending projection 40 on the cover member 8 that is captured in a blind cavity 42 formed in an upwardly extending stem 44 on the seal member upper side 12. In order to lock these components together, the projection 40 may be formed with flanges 46 and the cavity 42 may be formed with close-ended slots 48 that prevent the projection from being withdrawn from the cavity during normal use of the suction sealing apparatus 2. Note that although the cavity 42 has a closed bottom and does not penetrate completely through the seal member 6 to the seal member lower side 10, a modified form of the cavity could be used that does penetrate. In that case, the projection 40 on the cover member 8 could be configured as a removable sealing plug that can be retracted or otherwise manipulated within the cavity 42 to provide an alternative mechanism for releasing the seal member's suction sealing engagement with the reference surface 4.

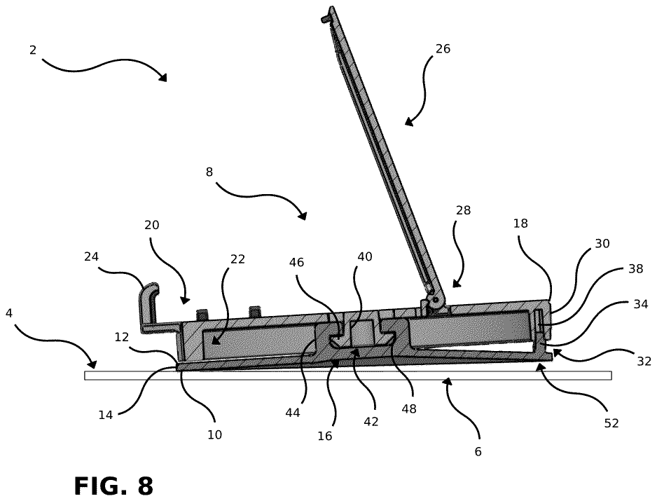

Turning now to FIGS. 7 and 8, it will be seen that the cover member 8 is manipulatable in a predetermined manipulation direction (e.g., counterclockwise tilting in FIG. 7) to activate the seal member suction release feature 32 in order to release the suction sealing engagement of the seal member 6 with the reference surface 4. Advantageously, the cover member 8 is manipulatable in other directions (e.g., clockwise tilting in FIG. 7, as well as other tilting directions) without activating the seal member suction release feature 32 and without releasing the suction sealing engagement of the seal member 6.

FIG. 7 shows the suction sealing apparatus 2 in an operational state wherein the entire peripheral region 10a of the seal member lower side 10 is in suction sealing engagement with the reference surface 4. The air pressure within the closed space (concavity 16) between the reference surface 4 and the seal member lower side 10 is either below the ambient air pressure outside the closed space, or will fall below ambient pressure in the event that the seal member 6 is deformed in a manner that increases the volume of the closed space.

The cover member 8 is in operable engagement at two locations on the seal member 6. First, the cover member 8 operably engages the suction release feature 32 proximate to the seal member peripheral edge 14 due to the pull member 34 being captured in the receptacle 38. Second, the cover member 8 also operably engages a central portion of the seal member 6 due to the cover member projection 40 being captured in the cavity 42 of the seal member stem 44 to establish a central connection. This central connection between the cover member 8 and the seal member 6 provides a fulcrum point for the cover member that allows it to function as a lever (when tilted counterclockwise in FIG. 7) to apply an upward pulling force on the pull member 34. This effects a manipulation of the cover member 8 in the cover member's predetermined manipulation direction.

In order to tilt the cover member 8 in the predetermined manipulation direction, a user of the suction sealing apparatus 2 may place one or more fingers on the cover member 8 at the location of the suction release feature 32 (shown by directional indicator 50 in FIGS. 4 and 5), and one or more other fingers on the opposite side of the cover member. The user may tilt the cover member 8 by lifting at the location of the suction release feature 32 in the upward direction indicated by the directional indicator 50 while pushing down on the opposite side. Alternatively, the user may simply lift without also pushing downwardly, and thus apply only an upward pulling force.

In either case, the seal member 6 will disengage from the reference surface 4 in the manner shown in FIG. 8. In particular, pulling upwardly on the pull member 34 via directional manipulation of the cover member 8 initiates directional peeling of the seal member 6. The directional peeling starts by lifting the seal member peripheral edge 14 and separating it from the reference surface 4 to effect a localized disruption of the ring seal between the peripheral region 10a of the seal member lower side 10 and the reference surface 4. The situs of the local seal disruption represents an incipient peel initiation region 52 on the seal member lower side 10 that is situated directly below the pull member 34 on the seal member upper side 12.

As the cover member 8 continues to exert an upward pull on the pull member 34, the directional peeling propagates away from the peel initiation region 52 across a remaining portion of the seal member lower side 10, enlarging in size as it does so. From a user standpoint, the user may (or may not) feel the seal member peripheral edge 14 begin peeling from the reference surface 4 in the vicinity of the suction release feature 32, followed by the remainder of the seal member lifting away from the reference surface 4 as the suction sealing apparatus 2 is freed therefrom. Depending on the size and other design characteristics of the seal member 6 and the cover member 8, and the amount of tilting force applied by the user, the directional peeling may ensue either gradually or rapidly.

As previously mentioned, the above-described directional peeling occurs when the cover member 8 is manipulated in its predetermined manipulation direction, which is counterclockwise in FIGS. 7 and 8. Advantageously, the cover member 8 is manipulatable in other directions without activating the seal suction release feature 32, and without releasing the suction sealing engagement of the seal member 6 with the reference surface 4. Such other directions (suction preservation directions) include counterclockwise tilting of the cover member 8 in FIGS. 7 and 8 (i.e., 180 degrees from the predetermined manipulation direction), as well as tilting in and out of the plane of FIGS. 7 and 8 (i.e., 90 and 270 degrees from the predetermined manipulation direction). In such other directions, the cover member manipulation does not impart a lifting force to the suction release feature 32, such that the seal member 6 remains in suction sealing engagement with no disruption of the ring seal between the peripheral region 10a of the seal member lower side 10 and the reference surface 4.

As also previously mentioned, further embodiments could be implemented wherein there is more than one instance of a suction release feature in a single suction sealing apparatus. For example, there could be embodiments with two suction release features situated 180 degrees apart, three suction release features situated 120 degrees apart, four suction release features located 90 degrees apart, and so on. In such embodiments, the cover member would have more than one corresponding manipulation directions (e.g., two, three, four, etc.). Alternatively, there could be several suction release features clustered together in order to increase the size of the peel initiation region, such as by widening it.

Turning now to FIGS. 9-11, a modified suction sealing apparatus 102 is shown to illustrate an alternative embodiment of the disclosed subject matter. The modified suction sealing apparatus 102 may employ essentially the same cover member 8 used in the previously described suction sealing apparatus 2, except that the receptacle 38 is not required. A more substantial difference in the modified suction sealing apparatus 102 is found in the use of a modified seal member 106 that includes a modified suction release feature 132. Apart from this structure, the modified seal member 106 includes many of the same features as the previously described seal member 6. Such features are shown by the use of corresponding reference numbers (incremented by 100).

The modified suction release feature 132 differs from the suction release feature 32 of the previously described seal member 6. Instead of a pull member 34, the modified suction release feature 132 is provided by a localized pocket formation 134 in the peripheral region 110a of the seal member lower side 110. The pocket formation 134 is formed as a permanent surface relief feature that provides an inherent gap between the seal member peripheral edge 114 and the reference surface 4 to prevent or disrupt the seal member's suction sealing engagement where the gap is situated. The pocket formation 134 may be created during the manufacturing process (e.g. injection molding) used to produce the modified seal member 106. Alternatively, it may be shape-formed following the initial manufacture of the modified seal member 106.

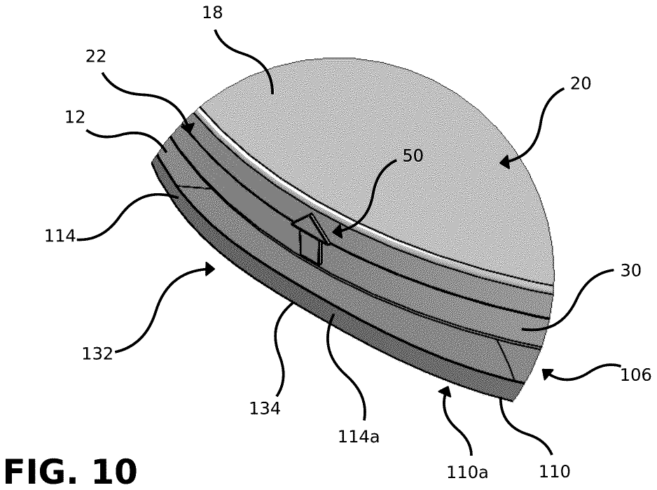

As best shown in FIG. 10, the pocket formation 134 may be configured as a discrete upwardly flared lip section 114a of the seal member peripheral edge 114. The flared lip section 114a creates a local discontinuity in the otherwise continuous ring seal that the peripheral region 110a of the seal member lower side 110 forms with the reference surface 4.

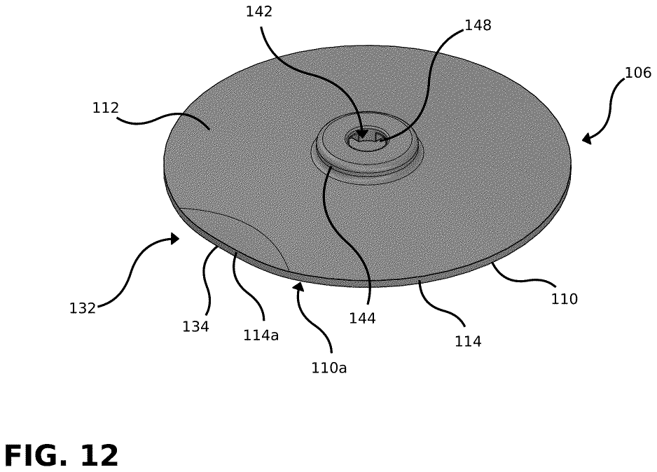

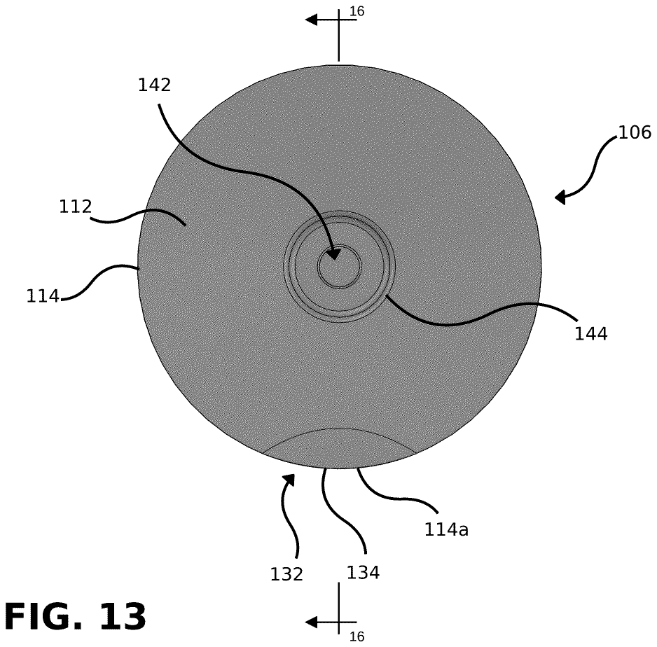

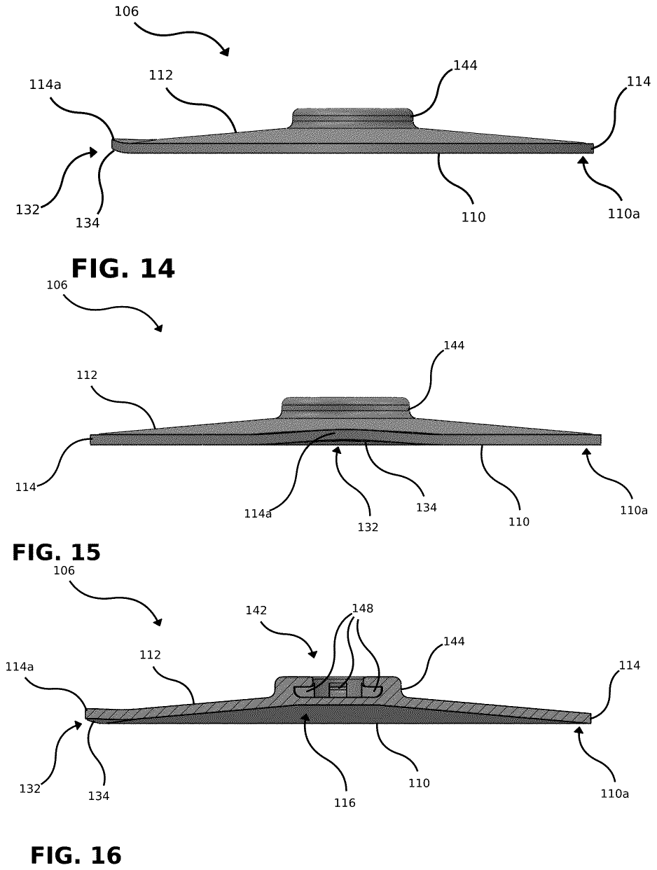

FIGS. 12-16 further illustrate these and other features of the modified seal member 106. FIGS. 12 and 13 depict the pocket formation 134 as having a lens-like shape when the modified seal member 106 is viewed from its upper (or lower) side. FIG. 13 depicts the pocket formation as having a maximum lateral depth (i.e., the radial inward distance from the seal member peripheral edge 114) at its midpoint. FIGS. 14 and 15 depict the height of the pocket formation 134 (extending away from the reference surface 4), with FIG. 15 also depicting the shape of the pocket formation when the modified seal member 106 is viewed from its edge 110. The edge-view shape of the pocket formation 134 is that of a shallow dome having an eyebrow configuration.

The radial depth, circumferential width and edge-view height of the pocket formation 134 need not be large. As discussed in more detail below, it is only necessary for successful action of the modified suction release feature 132 that the pocket formation 134 provide a local disruption of the ring seal between the reference surface 4 and the peripheral region 110a of the seal member lower side 110. By way of example, the maximum edge-view height of the pocket formation 134 may be on the order of 1-2 mm or less, the maximum radial depth of the pocket formation may be on the order of 5-10 mm or less, and the maximum circumferential width of the pocket formation may be on the order of 10 mm or less. Other dimensions may also be used, depending on the desired level of resistance to directional peeling that is required.

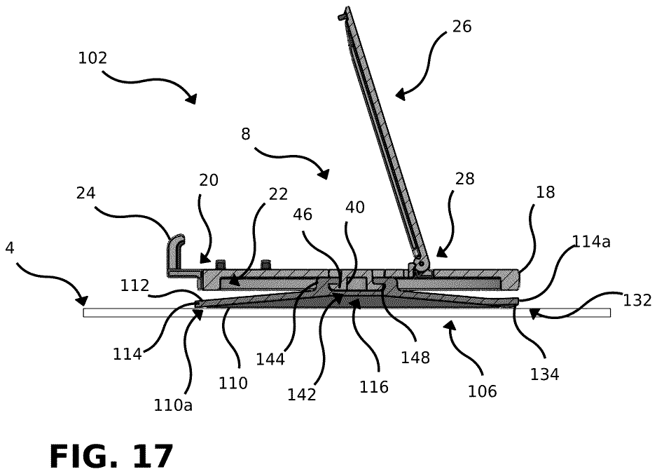

FIGS. 17-19 depict the operation of the modified suction sealing apparatus 102 during use. FIG. 17 shows the modified suction sealing apparatus 102 when placed on the reference surface 4 so that the peripheral region 110a of the modified seal member 106 is in nearly complete suction sealing engagement therewith. The only portion of the seal member's peripheral region 110a that does not seal against the reference surface 4 is at the pocket formation 134. The suction seal provided by the remainder of the seal member lower side 110 is sufficient for most applications given the relatively small surface area of the pocket formation 134 in comparison to the seal member lower side 110 as a whole. The modified seal member 110 will thus tend to remain adhered to the reference surface 4 so long as the cover member 8 is not manipulated in the predetermined manipulation direction.

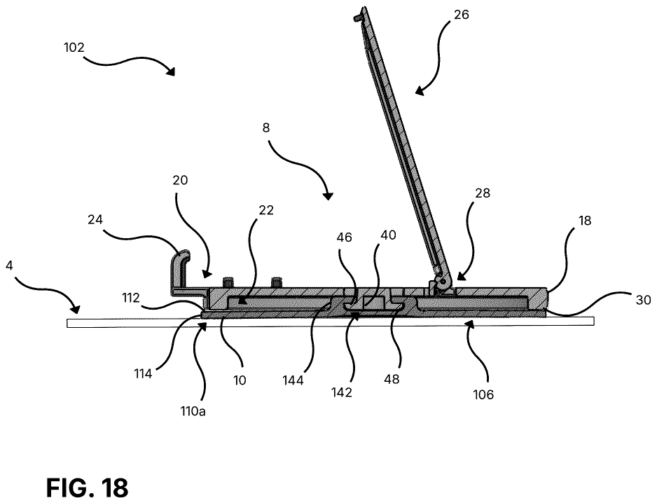

Moreover, full suction sealing engagement of the modified seal member 106 will be achieved in many cases as a result of the pocket formation 134 being collapsed downwardly and flattened against the reference surface 4, as shown in FIG. 18. This will occur as a matter of course for many usage scenarios due to the weight of the cover member 8 alone or due to an additional weight or external force of sufficient magnitude, such as the weight of an object that may be placed on the cover member. In either case, the pocket formation 134 will be flattened as a result of direct contact pressure exerted thereon by the seal member pressing structure 30 on the lower base portion 22 of the cover member 8. The seal member pressing structure 30 will press onto the seal member upper side 112 at a location that coincides with or is proximate to the modified suction release feature 132 shown in FIG. 17, and thereby collapse the pocket formation 134 to eliminate it as shown in FIG. 18.

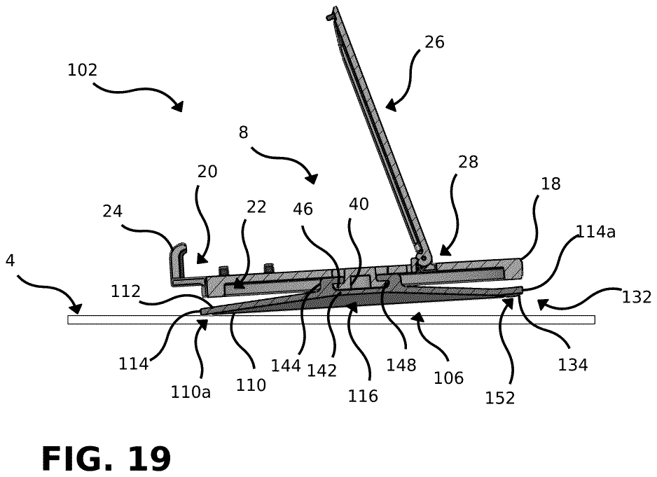

Regardless whether the modified seal member 106 is adhered to the reference surface 4 in the manner shown in either FIG. 17 or FIG. 18, the modified suction sealing apparatus 102 can be easily removed from the reference surface 4 by manipulating the cover member 8 in its predetermined manipulation direction. This is shown in FIG. 19.

The directional manipulation of the cover member 8 may be performed by tilting the cover member 8 in the predetermined manipulation direction (counterclockwise in FIG. 19). This will impart a torque to the modified seal member 106 due to the downward projection 40 on cover member 8 being captured in fixed relationship with the blind cavity 142 in the seal member stem 144. This mutual inter-engagement forms a rigid attachment connection between the cover member 8 and the modified seal member 106. Thus, when the cover member 8 is tilted in the predetermined manipulation direction, the resultant torque applied to the modified seal member 106 will apply a lifting force at the pocket formation 134. If the pocket formation 134 is in the uncollapsed state shown in FIG. 17, tiling the cover member 8 will cause the pocket formation to lift upwardly as a result of the applied lifting force. If the pocket formation 134 is in the collapsed state shown in FIG. 18, tilting the cover member 8 will initially cause the pocket formation 134 to re-form and then be lifted upwardly by the applied lifting force.

As previously noted, the pocket formation 134 provides a small inherent gap between the seal member peripheral edge 114 and the reference surface 4. This gap provides a local disruption that prevents the seal member's suction sealing engagement where the gap is situated. The gap defines a peel initiation region 152 where the suction resistance acting on the modified seal member 106 is eliminated locally. Because the pocket formation 134 is incapable of developing a seal, the lifting force applied thereto will draw the pocket formation 134 away from the reference surface at the peel initiation region 152 to initiate directional peeling of the modified seal member 106. As in the case of the previous embodiment described in connection with FIGS. 1-8, the directional peeling starts from the peel initiation region 152 and propagates away therefrom across a remaining portion of the seal member lower side 110 until the modified seal member 106 is freed from the reference surface 4.

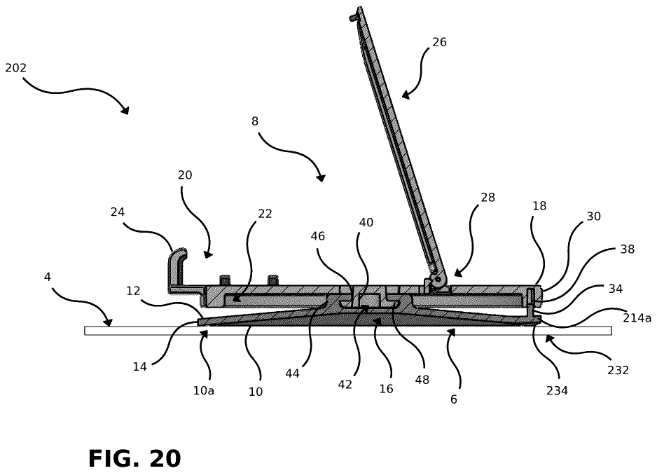

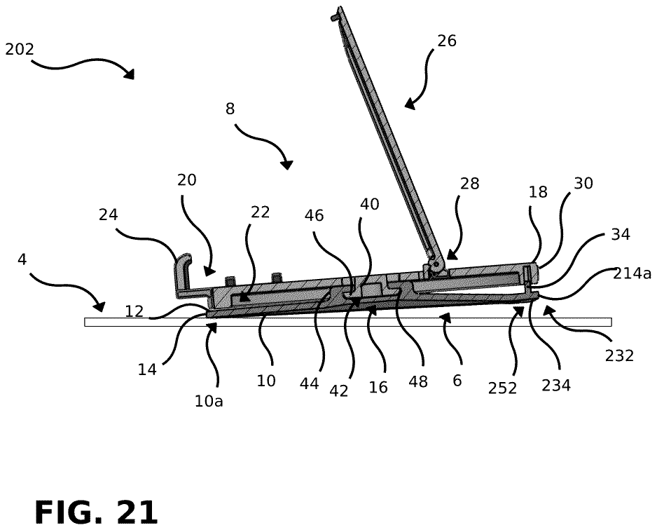

Turning now to FIGS. 20-21, the suction sealing apparatus 2 previously described in connection with FIGS. 1-8 is shown in a modified assembly state that results in a hybrid suction sealing apparatus 202. The hybrid suction sealing apparatus 202, which represents a further alternative embodiment of the disclosed matter, is similar in nearly all respects to the unmodified suction sealing apparatus 2. Where it differs is in its use of a hybrid suction release feature 232.

The hybrid suction release feature 232 includes the pull member 34 of the previously-described seal member 6, and it also includes a hybrid pocket formation 234. Although the hybrid pocket formation 234 resembles the previously-described pocket formation 134 of the modified seal member 106, it is formed in a different manner. Whereas the pocket formation 134 is inherently formed as a permanent surface relief feature of the modified seal member 106, the hybrid pocket formation 234 is formed by the engagement between the receptacle 38 on the lower base portion 22 of the cover member 8 and the pull member 34 on the seal member upper side 12. In particular, when the hybrid suction sealing apparatus 202 is assembled, the pull member 34 is inserted deeply enough into the receptacle 38 to lift up the seal member peripheral edge 14 at a localized peripheral edge region situated below the location of the pull member. This forms a hybrid flared lip 214a that creates the hybrid pocket formation 234. Like the pocket formation 134 of the previous embodiment described in connection with FIGS. 9-19, the hybrid pocket formation 234 provides a small inherent gap between the seal member peripheral edge 14 and the reference surface 4. This gap provides a local disruption that prevents the seal member's suction sealing engagement with the reference surface 4 where the gap is situated.

As in the case of the previously-described modified suction sealing apparatus 102, the suction sealing apparatus 202 is removable from the reference surface 4 by tilting the cover member 8 in a predetermined manipulation direction to initiate directional peeling. Due to the engagement between the pull member 34 on the seal member upper side 12 and the receptacle 38 on the cover member's lower base portion 22, a lifting force will be applied to the seal member 6, directly above the hybrid pocket formation 234. Because the hybrid pocket formation 234 is incapable of developing a seal, the lifting force applied thereto will draw the hybrid pocket formation away from the reference surface 4 at a hybrid peel initiation region 252 (see FIG. 21) where the suction resistance acting on the seal member 6 is eliminated locally. This initiates directional peeling of the seal member 6. As in the case of the previous embodiments, the directional peeling starts from the hybrid peel initiation region 252 and propagates away therefrom across a remaining portion of the seal member lower side 10 until the seal member 6 is freed from the reference surface 4.

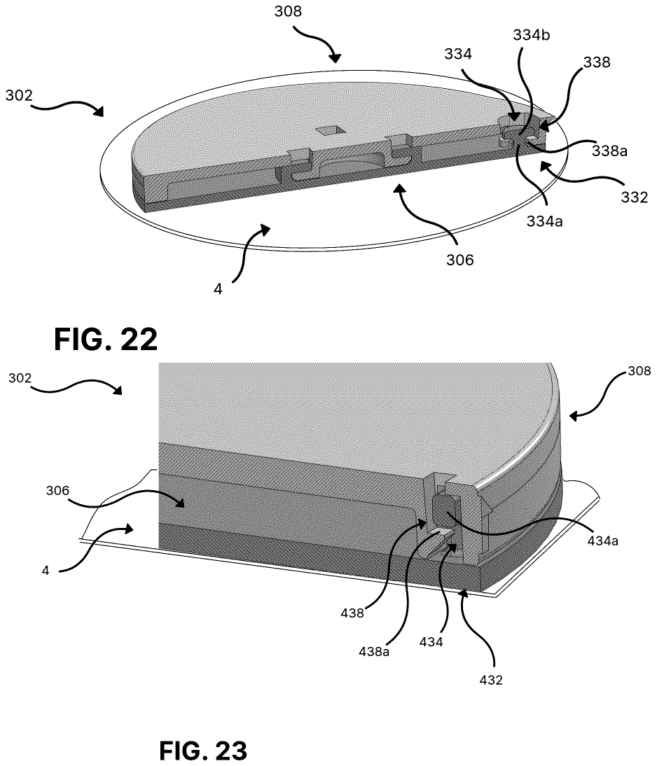

Turning now to FIG. 22, a modified suction sealing apparatus 302 is shown to illustrate a further alternative embodiment of the disclosed subject matter. The modified sealing apparatus 302 incorporates a delayed suction release feature 332 that may be useful for certain applications where resistance to substantial shock loads can be beneficial, such as mixing bowls and other kitchenware used for mixing, stirring and other food preparation operations involving vigorous movements.

The modified suction sealing apparatus 302 employs a modified seal member 306 and a modified cover member 308 to implement the delayed suction release feature 332. In particular, the modified seal member 306 is formed with a modified pull member 334 that slidably engages a modified pocket 338 of the modified cover member 308.

The modified pull member 334 may be formed as a retaining member that is slidably captured in the modified pocket 338 in a manner that allows the cover member 338 to be lifted a short distance without lifting the modified seal member 306 and dislodging it from the reference surface 4. Various retainer member configurations may be used to implement the modified pull member 334. In the embodiment of FIG. 22, the modified pull member 334 is formed as a flanged projection having a narrow shaft 334a and a flat head flange 334b at the top of the shaft. The pull member shaft 334a passes upwardly through a narrow pocket opening 338a of slightly larger size that is formed at the bottom of the cover member's modified pocket 338. The head flange 334b is slidably disposed above the pocket opening 338a in the modified pocket 338. The head flange 334b is sized so that it cannot readily pass through of the pocket opening 338a. For ease of assembly, the pocket opening 338a may be formed with a C-shaped (or U-shaped) configuration having a peripheral gap so that the pull member shaft 334a can be manipulated laterally into the pocket opening.

In the sealing position of the modified suction sealing apparatus 302 (shown in FIG. 22), the head flange 334b is spaced above the pocket opening 338a at a predetermined gap distance, such as 1-5 mm for example. When the modified cover member 338 is tilted or lifted in its predetermined manipulation direction, the modified cover member will not apply any substantial lifting force to the seal member 306 until the underside of the head flange 334b comes into engagement with the pocket structure surrounding the upper side of the pocket opening 338a. When such engagement occurs, the head flange 334b will begin to resist the upward movement of the cover member 308, resulting in a localized lifting force being applied to the modified seal member 306. As described in connection with previous embodiments, this will initiate directional peeling of the modified seal member 306, but only after the modified cover member 308 has been directionally manipulated a predetermined distance in its predetermined manipulation direction. The predetermined distance is dictated by the gap distance between the head flange 334b and the pocket opening 338a.

It will be appreciated that the onset of the modified seal member's directional peeling following initial contact between the head flange 334b and the pocket opening 338a may be rapid or gradual, depending on the configuration of the modified pull member 334. Rapid-onset directional peeling may be achieved by using a thick and relatively non-stretchable pull member shaft 334a and a flat bottomed head flange 334b. Gradual-onset directional peeling may be achieved by using a thin and relatively stretchable pull member shaft 334a and/or a tapered head flange 334b whose bottom end is sized to enter the top of the pocket opening 338a (which may also be tapered). The pull member shaft 334a may also be sized to provide some degree of frictional engagement with the pocket opening 338a.

In some cases, the gap distance between the pull member 334 and the pocket opening 338a may be reduced to zero in a gradual-onset directional peeling embodiment. In such cases, the delay in directional peeling can result inherently from the stretchability of the pull member 334. In a similar vein, it will also be appreciated that the pull member 38 of the suction sealing apparatus 2 (FIGS. 1-8) could likewise be configured as a stretchable member, and thereby provide gradual-onset directional peeling in that embodiment as well.

Regardless of how gradual-onset directional peeling is implemented, it can provide a form of shock absorption that helps increase the ability of the modified suction sealing apparatus 302 to withstand shock loads without loss of sealing. Instead of the shock loads being immediately applied to the modified seal member 306 at a magnitude that is sufficient to effect seal release, the shock loads can be buffered by the directional peeling delay-inducing components, absorbing energy such that the lift forces felt by the seal member in many cases never reach the magnitude at which seal release occurs.

Turning now to FIG. 23, a variant of the modified suction sealing apparatus 302 is shown with an alternative delayed suction release feature 432. The alternative delayed suction release feature 432 utilizes an alternative pull member 434 and an alternative pocket 438. The alternative pull member 434 is designed for delayed latching engagement with the alternative pocket 438. Although various latching arrangements may be used, the illustrated embodiment of FIG. 23 utilizes a loop latch and hook arrangement. In particular, the alternative pull member 434 is formed with a loop latch 434a and the alternative pocket 438 is formed with a hook 438a. The loop latch 434a is spaced by a predetermined gap distance (e.g., 1-5 mm, or 0 mm if gradual-onset directional peeling is desired) above the hook 438a when the variant suction sealing apparatus 302 is in sealing engagement with the reference surface 4. This is shown in FIG. 23. The loop latch 434a does not engage the hook 438a until the cover member 308 is tilted or lifted a predetermined distance in its predetermined manipulation direction. The predetermined distance is dictated by the gap distance between the loop latch 434a and the hook 438a. In this way, delayed suction release may be achieved.

Accordingly, embodiments of a suction sealing apparatus have been disclosed that includes a seal member and a cover member, with the seal member featuring a first side for suction sealing to a reference surface and a second side for operable engagement with the cover member. The seal member includes a suction release feature near its peripheral edge. The cover member is designed to activate the suction release feature, disengaging the seal member from the reference surface when manipulated in a specific direction, while allowing manipulation in other directions without releasing the seal, thus maintaining the seal member's attachment to the reference surface unless manipulated in the specific direction.

Although the suction sealing apparatus has been described and shown in the context of certain example embodiments, it should be apparent that variations and alternative embodiments could be implemented in accordance with the present disclosure. The disclosed suction apparatus may be embodied in many different shapes and sizes to operate with many different types of auxiliary structures that can be combined with or mounted to the cover member, including but not limited to bowls, buckets, cans, vases, urns, tanks, or other apparatus whose function is to hold or carry an object or material. Alternatively, the auxiliary structures may themselves represent objects or materials to be anchored instead of being holders or carriers for other objects or materials. Examples of such auxiliary structures include tools, implements, devices, equipment or other articles that could be integrated with, attached to, mounted on, or formed with the disclosed suction apparatus. Broadly speaking, the disclosed suction sealing apparatus may be used for anything imaginable that a user might wish to anchor to a reference surface. Alternatively, it should be understood that the disclosed suction sealing apparatus may be used for applications that do not involve auxiliary structures or the anchoring of object or materials other than the suction apparatus itself. Examples include medical applications such as therapeutic massage cupping, lifting applications such as sheet glass installation, retaining applications wherein two or more instances of the suction apparatus are situated around an object to serve as movement limiting stop members, and novelty/amusement applications.

Reference in the present disclosure to an “embodiment” means that a particular feature, structure or characteristic described in connection with the embodiment may be included in at least one embodiment of the disclosed apparatus. Thus, the appearances of the term “embodiment” in various places throughout the specification are not necessarily all referring to the same embodiment.

For purposes of explanation, specific configurations and details have been set forth herein in order to provide a thorough understanding of the disclosed subject matter. However, it will be apparent to one of ordinary skill in the art that embodiments of the present disclosure may be practiced without the specific details presented herein. Furthermore, well-known features may have been omitted or simplified in order not to obscure the present disclosure. Various examples may be given throughout this description. These examples are merely descriptions of specific embodiments of the disclosed subject matter. The scope of the disclosed subject matter is not limited to the examples given.

As used in this application, the terms such as “upper,” “lower,” “top,” “bottom,” “vertical,” “vertically,” “lateral,” “laterally,” “inner,” “outer,” “outward,” “inward,” “front,” “frontward,” “forward,” “rear,” “rearward,” “upwardly,” “downwardly,” “inside,” “outside,” “interior,” “exterior,” and other orientational descriptors are intended to facilitate the description of the example embodiments of the present disclosure, and are not intended to limit the structure of the example embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Terms of rough approximation, such as “generally,” are understood by those of ordinary skill to refer to a characteristic or feature of that bears resemblance to something, such that it is reasonable to draw a comparison to facilitate understanding, without requiring that the characteristic or feature be exactly the same, or even substantially the same, as the thing to which it is compared.

It is understood, therefore, that the disclosed subject matter is not to be in any way limited except in accordance with the spirit of the appended claims and their equivalents.

1: A suction sealing apparatus, comprising:
a seal member;
a cover member;
the seal member having a first side, a second side, and a peripheral edge;
a suction release feature formed on the seal member proximate to the seal member peripheral edge;
the seal member first side being configured for suction sealing engagement of the seal member to a reference surface;
the cover member overlying the seal member second side and operably engaging the suction release feature;
the cover member being manipulatable in a predetermined manipulation direction to activate the seal member suction release feature in order to release the suction sealing engagement of the seal member; and
the cover member being manipulatable in other manipulation directions without activating the seal suction release feature and without releasing the suction sealing engagement of the seal member.

2: The suction sealing apparatus of claim 1, wherein the seal member suction release feature comprises a pull member on the seal member second side that attaches to the cover member, the pull member substantially overlying a peel initiation region on the seal member first side, and wherein the manipulation of the cover member in the predetermined manipulation direction comprises moving the cover while leveraging its operable engagement with the seal member to draw the pull member away from the reference surface and initiate directional peeling of the seal member from the reference surface, the directional peeling starting from the seal member peel initiation region and propagating away therefrom across a remaining portion of the seal member first side.

3: The suction sealing apparatus of claim 2, wherein the peel initiation region comprises a localized pocket formation that creates a gap between the seal member peripheral edge and the reference surface that disrupts the seal member's suction sealing engagement where the gap is situated.

4: The suction sealing apparatus of claim 3 wherein the localized pocket formation is created as a result of the seal member being distorted by the attachment between the pull member and the cover member.

5: The suction sealing apparatus of claim 3, wherein the localized pocket formation is present when no weight or external force is applied to the seal member in the direction of the reference surface, but wherein the localized pocket formation flattens when a weight or external force of sufficient magnitude is applied to the seal member in the direction of the reference surface.

6: The suction sealing apparatus of claim 2, wherein the peel initiation region lies flat on the reference surface except when the pull member is pulled by the cover member.

7: The suction sealing apparatus of claim 1, wherein the seal member suction release feature comprises a localized pocket formation of the seal member that defines an inherent gap between the seal member peripheral edge and the reference surface to prevent the seal member's suction sealing engagement where the gap is situated, the localized pocket formation defining a peel initiation region on the first side of the seal member, and wherein the manipulation of the cover member in the predetermined manipulation direction comprises moving the cover member while leveraging its operable engagement with the seal member to draw the localized pocket formation away from the reference surface and initiate directional peeling of the seal member from the reference surface, the directional peeling starting from the seal member peel initiation region and propagating away therefrom across a remaining portion of the seal member first side.

8: The suction sealing apparatus of claim 7, wherein the localized pocket formation is permanently formed as a manufactured surface relief feature of the seal member.

9: The suction sealing apparatus of claim 7, wherein the localized pocket formation is present when no weight or external force is applied to the seal member in the direction of the reference surface, but wherein the localized pocket formation flattens when a weight or external force of sufficient magnitude is applied to the seal member in the direction of the reference surface.

10: The suction sealing apparatus of claim 9, wherein the localized pocket formation is flattened as a result of direct contact pressure by the cover member pressing on the seal member second side at a location that is proximate to the suction release feature.

11: The suction sealing apparatus of claim 1, wherein the cover member operably engages the seal member first side at one or more locations on the seal member second side.

12: The suction sealing apparatus of claim 1, wherein the cover member comprises a central projection that operably engages a central cavity on the seal member first side.

13: The suction sealing apparatus of claim 1, wherein the suction release feature is visually marked on the cover member to indicate the location of the suction release feature and the manipulation direction of the cover member.

14: The suction sealing apparatus of claim 1, wherein the seal member comprises more than one instance of the suction release feature.

15: The suction sealing apparatus of claim 1, wherein the cover member is configured and arranged for pressing engagement onto the seal member second side proximate to the seal member peripheral edge.

16: The suction sealing apparatus of claim 1, wherein the suction release feature is configured for delayed suction release operation in which suction release is delayed until the cover member is directionally manipulated a predetermined distance in the predetermined manipulation direction.

17: A suction sealing apparatus, comprising:
a seal member;
a cover member;
the seal member having a first side, a second side, a peripheral edge;
a suction release feature formed on the seal member proximate to the seal member peripheral edge;
the seal member first side being configured for suction sealing engagement of the seal member to a reference surface;
the seal member second side being configured for operable engagement of the seal member with the cover member;
the cover member being configured and arranged to activate the seal member suction release feature in order to release the suction sealing engagement of the seal member by directionally manipulating the cover member in a predetermined manipulation direction relative to the suction release feature;
the cover member being configured and arranged for manipulation in other directions without activating the seal suction release feature and without releasing the suction sealing engagement of the seal member, thereby ensuring that the seal member remains affixed to the reference surface; and
the seal member suction release feature comprising either:
(1) a pull member on the seal member second side that attaches to the cover member, the pull member substantially overlying a peel initiation region on the seal member first side, and wherein the manipulation of the cover member in the predetermined manipulation direction comprises moving the cover member while leveraging its operable engagement with the seal member to draw the pull member away from the reference surface to initiate directional peeling of the seal member from the reference surface, the directional peeling starting from the seal member peel initiation region and propagating away therefrom across a remaining portion of the seal member first side; or
(2) a localized pocket formation on the seal member that forms an inherent gap between the seal member peripheral edge and the reference surface to prevent sealing engagement therewith, the localized pocket formation defining a peel initiation region on the first side of the seal member, and wherein the manipulation of the cover member in the predetermined manipulation direction comprises moving the cover member while leveraging its operable engagement with the seal member to draw the localized pocket formation away from the reference surface to initiate directional peeling of the seal member from the reference surface, the directional peeling starting from the seal member peel initiation region and propagating away therefrom across a remaining portion of the seal member first side.

18: A method for using the suction sealing apparatus of claim 1, comprising:
adhering the suction sealing apparatus to a reference surface by placing the seal member first side on the reference surface to effect the suction sealing engagement between the seal member and the reference surface; and
detaching the suction sealing apparatus from the reference surface by manipulating the cover member in the predetermined manipulation direction to activate the suction release feature and thereby release the suction sealing engagement of the seal member.

19: The method of claim 18, wherein the manipulation of the cover member in the predetermined manipulation direction comprises tilting the cover member.

20: The method of claim 18, wherein the manipulation of the cover member in the predetermined manipulation direction comprises lifting the cover member.

21: A suction sealing apparatus, comprising:
a seal member;
a cover member;
the seal member having a first side, a second side, and a peripheral edge;
a suction release feature formed on the seal member proximate to the seal member peripheral edge;
the seal member first side being configured for suction sealing engagement of the seal member to a reference surface;
the cover member operably engaging the seal member second side;
the cover member being manipulatable in a predetermined manipulation direction to initiate directional peeling of the seal member at a peel initiation region location on the peripheral edge where the suction release feature is situated in order to release the suction sealing engagement of the seal member; and
the cover member being manipulatable in other manipulation directions without initiating the directional peeling of the seal member at the peel initiation region location and without releasing the suction sealing engagement of the seal member.

22: A method for using the suction sealing apparatus of claim 21, comprising:
adhering the suction sealing apparatus to a reference surface by placing the seal member first side on the reference surface to effect the suction sealing engagement between the seal member and the reference surface; and
detaching the suction sealing apparatus from the reference surface by manipulating the cover member in the predetermined manipulation direction to initiate the directional peeling of the seal member at a peel initiation region location and thereby release the suction sealing engagement of the seal member.
